(19) United States
(12) Patent Application Publication
(10) Pub. No.: US 2002/0010574 A1
(43) Pub. Date: Jan. 24, 2002

(54) Natural language processing and query driven information retrieval

(76) Inventors: Valery Tsourikov, Boston, MA (US); Igor Sovpel, Minsk (BY); Leonid Batchilo, Belmont, MA (US)

Correspondence Address: STANGER & DREYFUS, 608 SHERWOOD PKWY, MOUNTAINSIDE, NJ, 07092, US

(21) Appl. No.: 09/815,260

(22) Filed: Mar. 22, 2001

Related U.S. Application Data
(60) Provisional application No. 60/198,782, filed on Apr. 20, 2000.

(51) Int. Cl. G06F 17/27

(52) U.S. Cl. 704/9; 704/1; 707/3

(57) ABSTRACT

In a digital computer, the method of processing a natural language expression entered or downloaded to the computer that includes (1) identifying in the expression expanded subject, action, object components that includes at least four components, subject, action, object (SAO) components and at least one additional component from the class of preposition, indirect object, adjective, and adverbial eSAO components (2) extracting each of the at least four components for designation into a respective subject, action, object field and at least a preposition field, indirect object field, adjective field, and adverbial field, and (3) using the components in at least certain ones of said fields for at least one of (i) displaying components to the user, (ii) forming a search pattern of a user request for information search of local or on-line databases, and (iii) forming an eSAO knowledge base. A constraint field can also be provided to accept non-classified components.

### RELATED APPLICATION

U.S. patent application Ser. No. 60/198,782, filed Apr. 20, 2000.

### BACKGROUND

The present invention relates to methods and apparatus for semantically processing natural language text in a digital computer such that use of the processed data or representation shall lead to more reliable and accurate results than heretofore possible with conventional systems.

One example of such use includes processing user queries into search, retrieval, verification, and display desired information.

Another example is to analyze the content of processed information or documents and use such information to create a detailed and indexed knowledge base for user access and interactive display of precise information.

Reference is made to known systems for extracting, processing, and using SAO (Subject-Action-Object) data embodied in natural language text document in digital (electronic) form. These prior systems process native language user requests and/or documents to extract and store the SAO triplets existing throughout the document as well as the text segment associated with each SAO and link between each SAO and the Text segment. Links are also stored in association with each text segment and the full source document which is accessible by user interaction and input.

Although SAO extraction, processing, and management has advanced the science of artificial intelligence both stand-alone computer and web-based systems, there is a need in the art for yet greater accuracy in computer reliability in the semantic processing of user requests, knowledge base data, and information accessed and obtained on the web.

### SUMMARY OF EXEMPLARY EMBODIMENT OF INVENTION

It is an object of the present invention to expand the semantic processing power of computers to include not only the SAO but to use a new, more comprehensive, extended Subject-Action-Object (eSAO) format as the foundation for rule based processing, normalization, and management of natural language.

One skilled in this art will note that prior systems SAOs included three components, subject (S), action (A), Object (O), the expanded SAO (hereafter “eSAO”) includes a minimum of four components and fields and preferably seven components and fields. These additional fields include adjectives, prepositions, etc. more fully described below. In one exemplary embodiment, an eighth field is preferably provided into which all other components can be placed. These other components and eighth field are called constraints. Where the knowledge base or information in local and remote databases are to be accessed in response to a user request (or query) the system preferably uses the same rules and number of fields to process the natural language user request as to process candidate access or stored documents for presentation to user.

Thus, Semantic Processor for User Request Analysis according to the principles of the present invention aims at analyzing and classifying different types of user requests in order to create their formal representation (in the form of a set of certain fields and relations between them) which enables more effective and efficient answer search in local and remote databases, information networks, etc. Also, the output search patterns can be used to search for matching eSAO's in eSAO Knowledge Base in the system with much more accuracy and reliability than prior systems and methods even for requests being in the form of questions. In addition, the eSAO format enable greater accuracy in obtaining precise information of interest. One exemplary system according to the present invention also forms an eSAO knowledge base or index of stored processed information that can be managed by various rules related to the eSAO components and fields.

### DRAWINGS

Other and further objects and benefits shall become apparent with the following detailed description when taken in view of the appended drawings in which:

FIG. 1 shows a schematic view of one example of a digital computer system in accordance with the principles of the present invention.

FIG. 2 is an example of a classification routine for classifying the type of user request usable in the system of FIG. 1.

FIG. 3 is an example of a parsing routine for the case of user request being key words.

FIG. 4 is similar to FIG. 3 where user request is a bit (segment) sentence, command sentence or question sentence.

FIG. 5 shows a parsing routine for the case of user request being “bit”, “command”, “question” or “complex” query.

FIG. 6 shows a parsed synonymic search pattern expanding routine.

FIG. 7 shows a routing for generating the eSAO user request.

FIG. 8 shows the principal stages of forming as eSAO Knowledge Base or Index (90) and using a user natural language search query for relevant eSAO component and source information display from the knowledge base.

### DETAILED DESCRIPTION OF EXEMPLARY EMBODIMENT OF THE INVENTION

The following are incorporated herein by reference:

1. System and on-line information service presently available at www.cobrain.com and the publicly available user manual therefor.

2. The software product presently marketed by Invention Machine Corporation of Boston, USA, under it's trademark KNOWLEDGIST® and the publicly available user manual therefor.

3. WIPO Publication 00/14651, Published Mar. 16, 2000.

4. U.S. patent application Ser. No. 09/541,182 filed Apr. 3, 2000.

5. IMC's COBRAIN® server software marketed in the United States and manuals thereof.

See references Nos. 3, 4, and 5 above for systems and methods of using an SAO format for developing an SAO extracted Knowledge Base.

The system and method according to the present invention employs a new expanded S-A-O format for semantic processing documents and generating a database of expanded SAOs for expanded information search and management.

Note the prior systems SAOs included three components, subject (S), Action (A), Object (O), whereas one example of expanded SAOs (hereafter “eSAO”) includes a minimum of 4 classified components up to 7 classified components (preferably 7 classified fields) and, optionally, an 8^{th} field for unclassified components.

In one example, the Extended SAO (eSAO)—components include:

1. Subject (S), which performs action A on an object O;

2. Action (A), performed by subject S on an object O;

3. Object (O), acted upon by subject S with action A;

4. Adjective (Adj.)—an adjective which characterizes subject S or action A which follows the subject, in a SAO with empty object O (ex: “The invention is efficient”, “The water becomes hot”);

5. Preposition (Prep.)—a preposition which governs Indirect Object (Ex: “The lamp is placed on the table”, “The device reduces friction by ultrasound”);

6. Indirect object (iO)—a component of a sentence manifested, as a rule, by a notional phrase, which together with a preposition characterizes action, being an adverbial modifier. (Ex: “The lamp is placed on the table”, “The light at the top is dim”, “The device reduces friction by ultrasound”);

7. Adverbial (Adv.)—a component of a sentence, which characterizes, as a rule, the conditions of performing action A. (Ex: “The process is slowly modified.”, “The driver must not turn the steering wheel in such a manner.”)

Examples of application of the eSAO format are:

| 1. | Input: Is the moon really blue during a blue moon? | |
|---|---|---|
| | Output: | |
| | Subject: | moon |
| | Action: | be |
| | Object: | — |
| | Preposition: | during |
| | Indirect Object: | blue moon |
| | Adjective: | really blue |
| | Adverbial: | — |

| | |
|---|---|
| 2. | Input: Does the moon always keep the same face towards |

the Earth?

| | |
|---|---|
| Output: | |
| Subject: | moon |
| Action: | keep |
| Object: | same face |
| Preposition: | towards |
| Indirect object: | Earth |
| Adjective: | — |
| Adverbial: | always |

| 3. | Input: |
|---|---|
| | The dephasing waveguide is fitted with a thin |
| | dielectric semicircle at one end, and a guide cascaded |
| | with the dephasing element completely suppresses |
| | unwanted modes. |
| | Output: |
| | Subject: guide cascaded with the dephasing element |
| | Action: suppress |
| | Object: unwanted mode |
| | Preposition: — |
| | Indirect Object: — |
| | Adjective: — |
| | Adverbial: completely |
| 4. | Input: |
| | It was found that the maximum value of x is dependent |
| | on the ionic radius of the lanthanide element. |
| | Output: |
| | Subject: maximum value of x |
| | Action: be |
| | Object: — |
| | Preposition: on |
| | IndirectObject: ionic radius of the lanthanide element |
| | Adjective: dependent |
| | Adverbial: — |
| 5. | Input: |
| | This was true even though the RN interphase reacted |
| | and vaporized because of water vapor in the atmosphere |
| | at intermediate temperatures and glass formation |
| | occurred at higher temperatures. |
| | Output: |
| | Subject: glass formation |
| | Action: occur |
| | Object: — |
| | Preposition: at |
| | IndirectObject: higher temperature |
| | Adjective: — |
| | Adverbial: — |
| 6. | Input: |
| | The composites were infiltrated under vacuum, cured |
| | at 100 degree C, and precalcined in air at 700 degree |
| | C. |
| | Output: |
| | Subject: — |
| | Action: infiltrate |
| | Object: composite |
| | Preposition: under |
| | IndirectObject: vacuum |
| | Adjective: — |
| | Adverbial: — |

In addition, Subject S, Object O and Indirect Object iO have their inner structure, which is recognized by the system and includes the components proper (Sm, Om, iOm) and their attributes (Attr (Sm), Attr(Om), Attr(iOm)). The elements of each of the pairs are in semantic relation P between each other.

If, for purposes of the following description, we denote any of the elements Sm, Om, iOm as Ôm, then Subject S, Object O and Indirect Object iO are predicate elements of the type P(Attr(Ôm), Ôm). The system considers and recognizes following types of relation P: Feature (Parameter, Color, etc.), Inclusion, Placement, Formation, Connection, Separation, Transfer, etc.

Examples (Only sentence fragments are given here, which correspond to the S or O or iO):

1. Input: Ce-TZP materials with CeO₂ content Output: P=Formation/with Attr (Ôm)=CeO₂ content Ôm=Ce-TZP materials

2. Input: rotational speed of freely suspended cylinder Output: P=Feature (Parameter)/of Attr (Ôm)=rotational speed Ôm=freely suspended cylinder

3. Input: ruby color of Satsuma glass Output: P=Feature (Color)/of Attr (Ôm)=ruby color Ôm=Satsuma glass

4. Input: micro-cracks situated between sintered grains Output: P=Placement/situated between Attr (Ôm)=sintered grains Ôm=micro-cracks

5. Input: precursor derived from hydrocarbon gas Output: P=Formation/derived from Attr (Ôm)=hydrocarbon gas Ôm=precursor

6. Input: dissipation driver coupled to power dissipator Output: P=Connection/coupled to Attr (Ôm)=power dissipator Ôm=dissipation driver

7. Input: lymphoid cells isolated from blood of AIDS infected people Output: P=Separation/isolated from Attr (Ôm)=blood of AIDS infected people Ôm=lymphoid cells

8. Input: one-dimensional hologram pattern transferred to matrix electrode Output: P=Transfer/transferred to Attr (Ôm)=matrix electrode Ôm=one-dimensional hologram pattern

It is clear, that the components Ôm proper can also be predicate elements (in the given above examples, it is, for instance, Ex. No. 2: Ôm−freely suspended cylinder, Ex. No. 8: Ôm=one-dimensional hologram pattern). It should be noted that for information retrieval purposes it is more important to recognize the structure of Subject, Object and Indirect object, that is Attr (Ôm) and Ôm than the types of relation P, because it is the basis of the algorithm of transition to the less relevant search patterns.

Semantic Processor for User Request Analysis according to the principles of the present invention aims at analyzing and classifying different types of user requests in order to create their formal representation (in the form of a set of certain fields and relations between them) which enables more effective and efficient search for information or documents in local and remote databases, knowledge bases, information networks, etc.

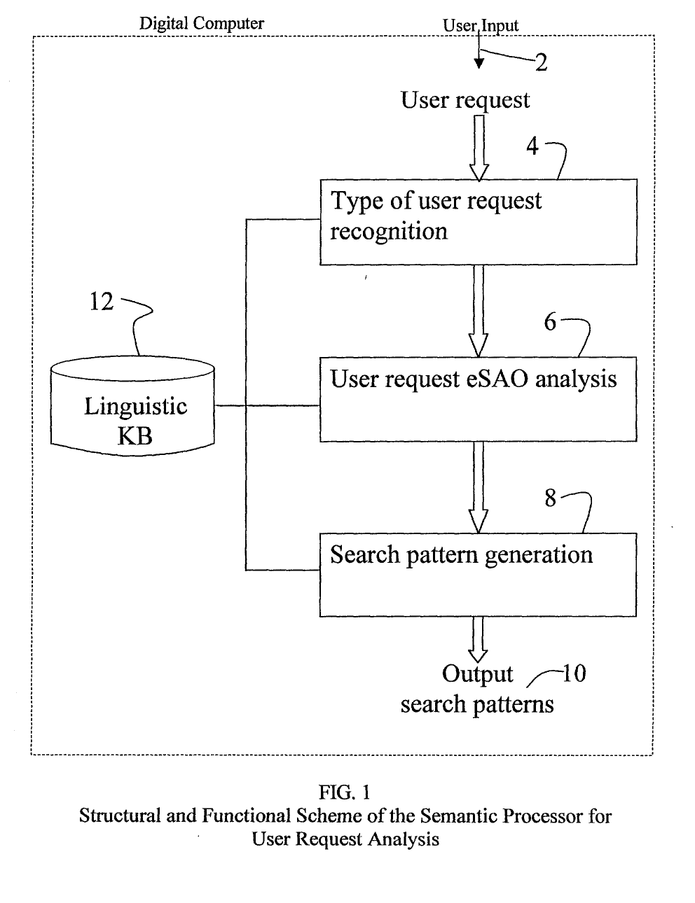

Semantic Processor (FIG. 1) receives User Request 2 as input data. Using Linguistic KB 12, Semantic Processor identifies or classifies the type of request as described below (Unit 4) and performs eSAO analysis of the request in accordance with its type (Unit 6). Then, a number of search patterns is generated corresponding to the input user request which represent its formal description designed for answer search (Unit 10) in databases, information networks, etc.

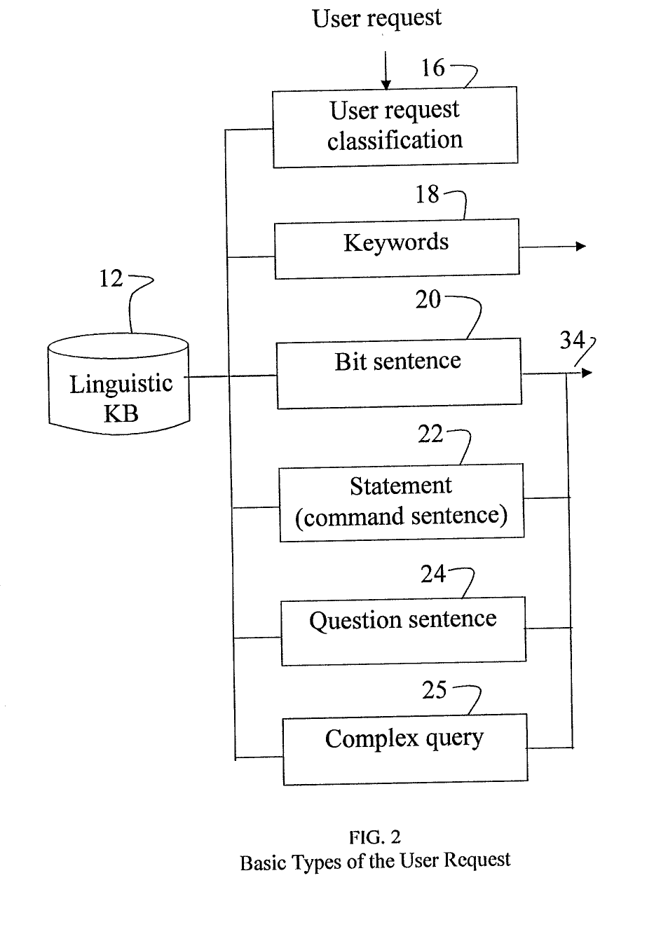

Semantic Processor analyzes the following basic types of requests (FIG. 2).

1. Keywords (18)

Keywords is a type of user request where words are organized into a Boolean expression using predetermined grammar rules. In one example, it comprises 6 rules for infix, prefix and brackets operators. The following operators are implemented: AND, OR, XOR, NEAR, NOT and brackets. The operators may be expressed in user request in different ways, for instance AND can be written as ‘AND’, ‘&’, ‘&&’, ‘+’.

User request example:

“(‘laser’ NEAR ‘beam’) && ‘heating’”

2. Bit sentence (20)

Bit sentence is a type of user request representing a part of sentence or sentence segment (incomplete sentence) which corresponds to a certain semantic element:process, object, function (action+object), etc.

User request examples:

(a) solid state laser system

(b) decrease friction

3. Statement (22)

Statement is a type of request which is a grammatically correct imperative sentence.

User request example:

Give me the number of employees in your company.

4. Question sentence (24)

Question sentence is a type of request which is a grammatically correct interrogative sentence.

User request examples:

(a) What causes fuel cell degradation?

(b) What is the chemical composition of the ocean?

(c) Do the continents move?

5. Comlex query (25)

Complex query is a type of request, which is expressed, by several sentences, i.e. by the fragment of the text.

User request example:

(a) Is there anything I can give my one-month-old son to relieve gas pain? I think he may have colic.

(b) My 15-year-old son has recently been diagnosed with recurrent shoulder dislocation. Lately he got worse. How is recurrent shoulder dislocation treated?

(c) Because I have a chronic stuffed nose and no sense of taste, I have been taking a prescribed medicine (Claritin D). Is there a time limit after which this medicine will no longer have an effect? If so, what else can I take?

(d) Three years ago, after months of extreme fatigue, general aches and pains and stomach problems, my family doctor gave me a diagnosis of Epstein-Barr. He said my titers were 5100. Recently I went to an internist, who ran numerous blood tests and said she thinks that I have fibromyalgia. She doesn't believe in the Epstein-Barr diagnosis. I am now being referred to a rheumatologist. Is there such a thing as Chronic Epstein-Barr? And what is the difference between Epstein-Barr and fibromyalgia?

After the type of request has been classified, the request is forwarded to eSAO module for further analysis (Unit 6).

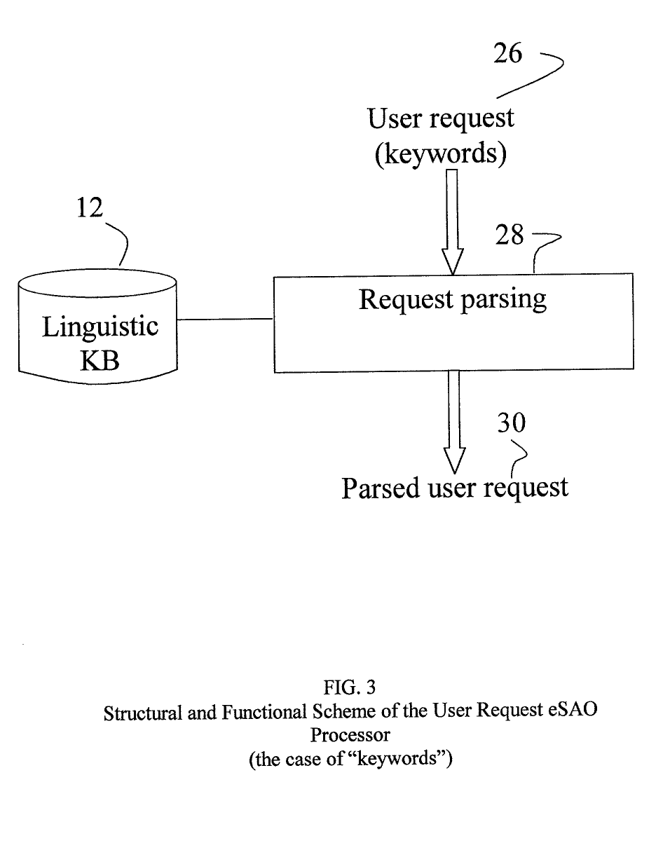

If the request has been recognized as “Keywords”, i.e. it satisfies the rules of Boolean grammar, Semantic Processor converts the request into standard notation. See FIG. 3. For example:

Input

“(‘laser’ NEAR ‘beam’) && ‘heating’”

Output

((laser) NEAR (beam)) AND (heating)

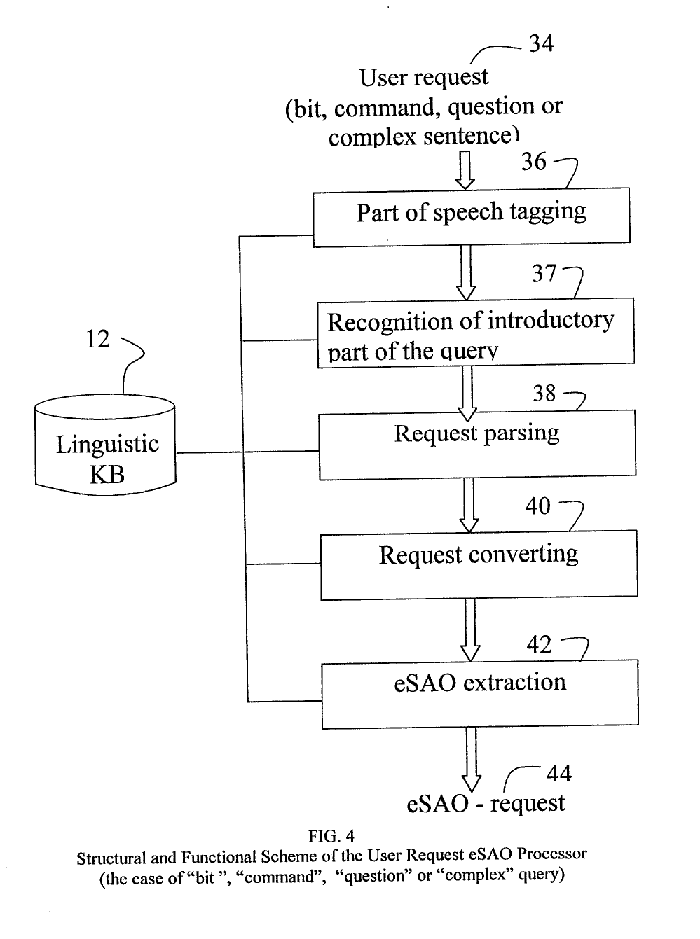

If the request is of the type “bit” or “command” or “question sentence” or “complex query”, eSAO Processor (FIG. 4) performs its tagging (Unit 36), recognizing introductory part of the request (Unit 37), parsing (Unit 38), conversion (Unit 40). If the request type is “question sentence”, semantic analysis (e-SAO extraction) (Unit 42), and outputs formal representation of the original request in the form of a set of predetermined fields.

At the step of tagging (Unit 36), each word of the request is assigned a Part-Of-Speech tag (its lexical-grammatical class). The analysis used here (see above identified references Nos. 3 and 4) is supplemented with statistical data, obtained on the specially collected question corpus. This provides highly correct POS-tagging. In case of “bit sentence” several variants are possible.

For instance:

Input

clean water

Output

(a) clean_JJ water_NN

(b) clean_VB water_NN

where JJ stands for adjective, VB—verb, NN—noun

Then, (Unit 37) the introductory part of the query is recognized, which is a sequence of words in the beginning of the query, none of which is a keyword for the given query. For example:

a) Could you tell me . . .

b) Is it true, that . . .

c) I want . . .

This part of the query is excluded from further processing or analysis. The recognition of the introductory part is performed by means of patterns, making use of separate lexical units and tags.

For example:

a) <PP BE (interested|wondering) (if|whether) [,]>

This pattern removes, for example, the following part from the user's query:

I am wondering if . . .

b) <MD PP VB PP [,]>

This pattern removes, for example, the following part from the user's query:

Could you tell me . . .

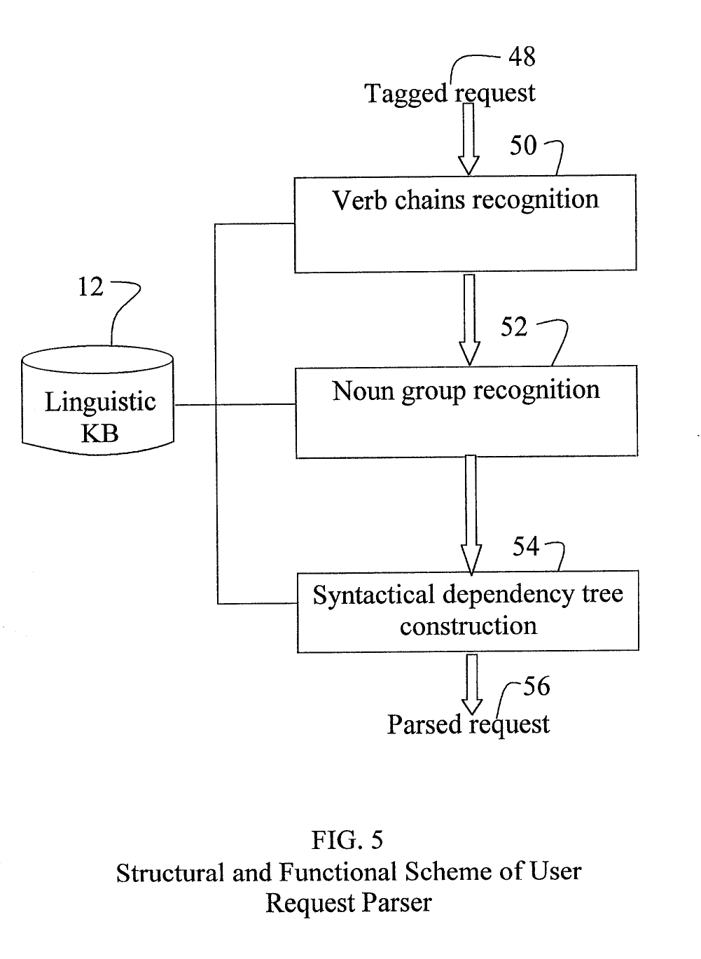

At the step of parsing, FIG. 4, verbal sequences (Unit 50) and noun phrases (Unit 52) are recognized from the tagged request (FIG. 5) and a syntactical parse tree is built (Unit 54).

This module includes stored Recognizing Linguistic Models for Syntactic Phrase Tree Construction. They describe rules for structurization of the sentence, i.e. for correlating part-of-speech tags, syntactic and semantic classes, etc. which are used by Text parsing and SAO extraction for building Syntactic and Functional phrases (see Reference No. 4 (i.e. U.S. Patent application Ser. No. 09/541,182), page 36, section “Tree Construction”).

The Syntactical Phrase Tree Construction is based on context-sensitive rules to create syntactic groups, or nodes in the parse tree.

A core context-sensitive rule can be defined by the following formula:

UNITE

[element_{—}1 . . . element_n] AS Group_X

IF

left context=L_context_{—}1 . . . L_context_n

right_context=R_context_{—}1 . . . R_context_n

which means that the string in brackets (element_{—}1 . . . element_n) must be united and further regarded as a syntactic group of a particular kind, Group_X in this case, if elements to the left of the string conform to the string defined by the left_context expression, and elements to the right of the string conform to the string defined by the right_context expression.

Elements here can be POS-tags or groups formed by the UNITE command.

All sequences of elements can consist of one or more elements.

One or both of context strings defined by left_context and right_context may be empty.

The context-sensitive rules are applied to a sentence in a backward scanning, from the end of the sentence to beginning, element by element, position by position. If the present element or elements are the ones defined in brackets in one of the context-sensitive rules, and context restricting conditions are satisfied, these elements are united as a syntactic group, or node, in the parse tree. After that the scanning process returns to the last position of the sentence, and the scan begins again. The scanning process is over only when it reaches the beginning of the sentence not starting any rule. Preferably, after a context-sensitive rule has implemented, elements united into a group become inaccessible for further context-sensitive rules, instead, this group represents these elements.

A simple example illustrates the above mentioned stages.

Input Sentence

The device has an open distal end.

The_DEF_ARTICLE device_NOUN has_HAVE_s an_INDEF_ARTICLE open_ADJ distal_ADJ end_NOUN._PERIOD Grammar:

BEGIN₁₃ BACKWARD_STAGE

UNITE

[(ADJ or NOUN) (NOUN or Noun_Group)] AS Noun_Group

IF

left_context=empty

right_context=empty

UNITE

[(DEF_ARTICLE or INDEF_ARTICLE) (NOUN or Noun_Group)]

AS Noun_Group

IF

left_context=empty

right_context=empty

END_BACKWARD_STAGE

Rule 1 (ADJ and NOUN):Pass 1

The_DEF_ARTICLE device_NOUN has_HAVE_s an INDEF ARTICLE open (Noun_Group: distal_ADJ end_NOUN)._PERIOD

Rule 1 (ADJ and Noun_Group):Pass 2

The_DEF_ARTICLE device_NOUN has_HAVE_s an_INDEF_ARTICLE (Noun_Group: open_ADJ (Noun_Group: distal_ADJ end_NOUN))._PERIOD

Rule 2 (INDEF_ARTICLE and Noun_Group):Pass 3

The_DEF_ARTICLE device_NOUN has_HAVE_s (Noun_Group: an_INDEF_ARTICLE (Noun_Group: open_ADJ (Noun_Group: distal_ADJ end_NOUN)))._PERIOD

Rule 1 (DEF_ARTICLE and NOUN):Pass 4

(Noun_Group: The_DEF_ARTICLE device_NOUN) has_HAVE_s

(Noun_Group: an_INDEF_ARTICLE (Noun_Group: open_ADJ

(Noun_Group: distal_ADJ end_NOUN)))._PERIOD

Now there exists two nodes, or groups—noun groups. Only one more rule is needed to unite a noun group, HAS-verb and one more noun group as a sentence.

Thus, the first stage in parsing deals with POS-tags, then sequencies of POS-tags are gradually substituted by syntactic groups, these groups are then substituted by other groups, higher in the sentence hierarchy, thus building a multi-level syntactic structure of sentence in the form of a tree.

For instance (first, the results are presented for the four sentences given above):

1) The dephasing wave guide is fitted with a thin dielectric
semicircle at one end, and a guide cascaded with the
dephasing element completely suppresses unwanted modes.
w__Sentence

w__N_XX

w_NN

a_AT
guide_NN
w__VBN_XX
cascaded_VBN
w__IN_N

with_IN
w_NN

the_ATI
w_NN

dephasing_NN
element_NN

w__VBZ_XX

w__VBZ

completely_RB
suppresses_VBZ

w_NNS

unwanted_JJ
modes_NNS

·_·
2) It was found that the maximum value of x is dependent on
the ionic radius of the lanthanide element.
w__Sentence

w_NN

w_NN

the_ATI
w_NN

maximum_JJ
value_NN

of_IN
x_NP

w__BEX_XX

is_BEZ
w__JJ_XX

dependent_JJ
w__IN_N

on_TN
w_NN

w_NN

the_ATI
w_NN

ionic_JJ
radius_NN

of_IN
w_NN

the_ATI
w_NN

lanthanide_NN
element_NN

3) This was true even though the BN interphase reacted and
vaporized because of water vapor in the atmosphere at
intermediate temperatures and glass formation occurred at
higher temperatures.
w__Sentence

w_NN

glass_NN
formation_NN

w__VED_XX

occurred_VBD
w__IN_N

at_IN
w_NNS

higher_JJR
temperatures_NNS

·_·
4) The composites were infiltrated under vacuum, cured at
100 degree C, and precalcined in air at 700 degree C.
w__Sentence

w_NNS

The_ATI
composites_NNS

w__BEX_XX
were_BED
w__VEN_XX

infiltrated_VBN
w__IN_N

under_IN
vacuum_NN

·_·
5) “bit sentence” type
Input:

clean water

Output:

a) <w_NN>

<clean_JJ> clean_JJ
<water_NN> water_NN

b) <w__VP_XX>

<clean_VB> clean_VP
<water_NN> water_NN

6) “question sentence” type
Input:

What causes fuel cell degradation?

Output:
<w__q_Sentence>

| | |
|---|---|
| <What_WDT> | What_WDT |
| <w__VBZ_XX> | |

| | |
|---|---|
| <causes_VBZ> | causes_VBZ |
| <w_NN> | |

| | |
|---|---|
| <fuel_NN> | fuel_NN |
| <w_NN> | |

| | |
|---|---|
| <cell_NN> | cell_NN |

<degradation_NN> degradation_NN

| | |
|---|---|
| <?_?> | ?_? |

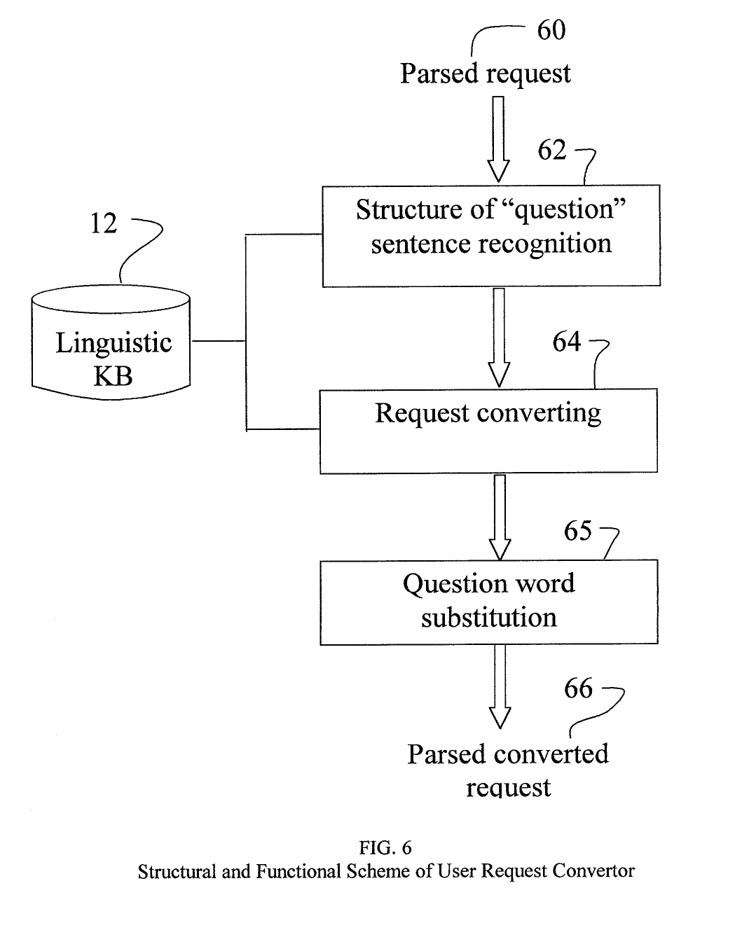

At the stage of question transformation or conversion (FIG. 6), in case of “question sentence” question structure is first recognized according to its general description (Unit 62). This formal description concerns only that introductory part of the query or the whole query, which will be transformed later on, and it is given in the following Backus-Naur notation:

1. <Question>::=[<Wh-group>]<First Verbal Group>NG

[<Second Verbal Group >]

Notes: a) [x] means, that x element may be absent;

b) NG—noun group;

2. <Wh-group>::=[Pr]<Wh>[NG]

Notes: Pr—preposition;

3.<Wh>::=enc_WP|enc_WRB|enc_WDT|<How RB>

Notes: a) enc|X means represents a lexical unit with a terminal symbol X, being its POS-tag;

b) enc_WP, enc_WRB and enc_WDT tags cover all possible question words: how long, how much, how many, when, why, how, where, which, who, whom, whose, what.

4. <How RB>::=how enc_RB

5. <First Verbal Group>::=enc_MD|enc_HV|enc_HVZ|enc_HVD|enc_HVN|enc_BE|enc_BEZ |enc_BEM|enc_BER|enc_BED|enc_BEDZ|enc_DO|enc_DOD|enc _DOZ

6. <Second Verbal Group>::=<First Verbal Group>|enc_VB|enc_VBZ|enc_VBD|enc_VBN enc_VBG enc_HVG|enc_BEN|enc_BEG|enc_XNOT

It should be noted, that above-described grammar is build so as not to process posed to syntactic subjects—“What food can reduce cholesterol in blood?”, “Who killed Kennedy?”, because the word order in these questions is direct (statement-like) and does not need to be changed. Besides, the remaining part of the question we mark as TL (“tail”).

In one example of the converting step 40, the elements in the right side of formula 1 are enumerated:

1. <Wh-group>

2. <First Verbal Group>

3. NG

4. <Second Verbal Group>and TL is marked as 5

Then, the formula of the query itself will be:

request=(1,2,3,4,5)

In some cases certain elements of the formula may be absent.

For example:

a) What is the chemical composition of the ocean? →1 (What) 2 (is) 3 (the chemical composition of the ocean) 4( ) 5( )?

b) Do the continents move? →1 ( ) 2 (Do) 3 (the continents) 4 (move) 5 ( )?

c) How much did it help? →1 (How much) 2 (did) 3 (it) 4 (help) 5 ( )?

d) 1 (What company) 2 (is) 3 (John) 4 (working) 5 (at the moment for)→3 (John) 2 (is) 4 (working) 5 (at the moment for) 1 (what company)

e) 1 (For what company) 2 (is) 3 (John) 4 (working) 5 (at the moment)→3 (John) 2 (is) 4 (working) 1 (for what company) 5 (at the moment)

After the structural formula of the request has been defined, the question is converted (Unit 64) according to the following rule:

(1 2 3 4 5)→(3 2 4 1 5)

or

(1 2 3 4 5)→(3 2 4 5 1)

The second formula may be regarded as a special type of the first one, connected with grammatical peculiarities of the question.

For example:

a) 1 (What) 2 (is) 3 (the chemical composition of the ocean) 4 ( ) 5 ( )? →3 (the chemical composition of the ocean) 2 (is) 4 ( ) 1 (What) 5 ( )

b) 1 ( ) 2 (Do) 3 (the continents) 4 (move) 5 ( )? →3 (the continents) 2 (Do) 4 (move) 1 ( ) 5 ( )

c) 1 (How much) 2 (did) 3 (it) 4 (help) 5 ( )? →3 (it) 2 (did) 4 (help) 1 (How much) 5 ( )

d) 1 (What company) 2 (is) 3 (John) 4 (working) 5 (at the moment for)→3 (John) 2 (is) 4 (working) 5 (at the moment for) 1 (what company)

e) 1 (For what company) 2 (is) 3 (John) 4 (working) 5 (at the moment)→3 (John) 2 (is) 4 (working) 1 (for what company) 5 (at the moment)

The described transformations of the questions enable to transform them into narrative form, which can be easily translated into the search pattern.

Then, converted request is subjected to the “question word substitution”. In accordance with special rules, question words are substituted with certain, so-called “null-words” so as not to corrupt sentence structure:

| | |
|---|---|
| What | Something1 |
| Which | Some |
| How | Somehow |
| Who | Someone1 |
| How long | Sometime |
| Whom | Someone2 |
| How much | Something2 |
| How many | Something3 |
| Where | Somewhere |
| When | Time clause |
| Why | Reason clause |
| Whose | Somebody's |

Then the parsed converted request is submitted to User Request eSAO extraction 44.

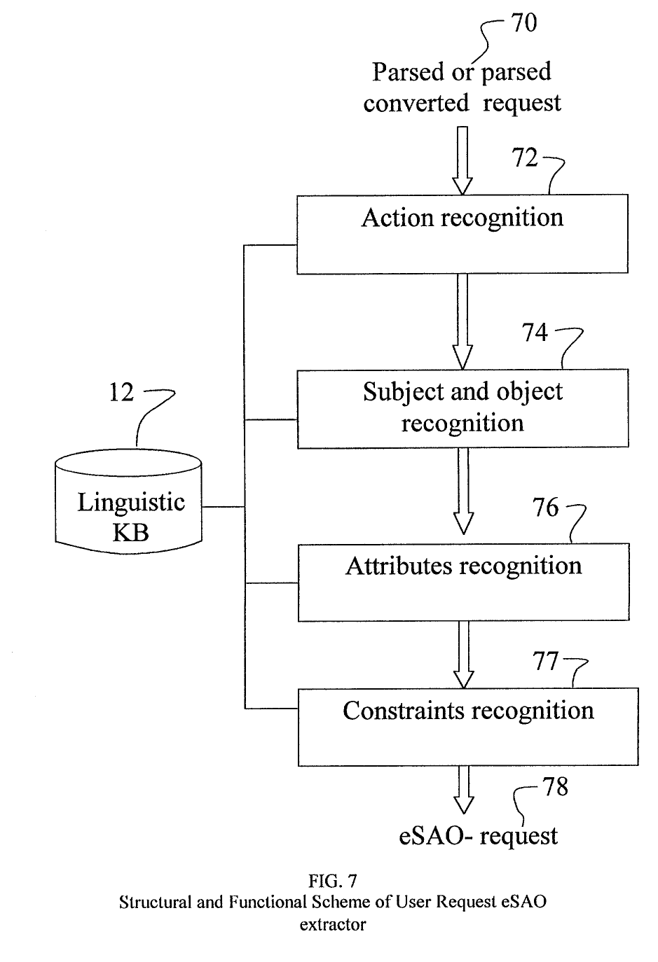

At the stage of eSAO extraction (FIG. 7), in the user request (in all cases except “keywords” case) semantic elements are recognized of the type S-subject (Unit 74), A-action (Unit 72), O-object (Unit 74) as well as their attributes expressed via preposition, indirect object, adjective, adverbial, as well as inner structure (the components proper and the attributes) of Subject S, Object O and Indirect Object iO.

The recognition of all these elements is implemented by means of corresponding Recognizing Linguistic Models (see Reference No. 4 (i.e. U.S. patent application Ser. No. 09/541,182) page 41, section “SAO Recognition”). These models describe rules that use part-of-speech tags, lexemes and syntactic categories which are then used to extract from the parsed text eSAOs with finite actions, non-finite actions, verbal nouns. One example of Action extraction is:

<HVZ><BEN><VBN>=>(<A>=<VBN>)

This rule means that “if an input sentence contains a sequence of words w1, w2, w3 which at the step of part-of-speech tagging obtained HVZ, BEN, VBN tags respectively, then the word with VBN tag in this sequence is in Action”.

For example,

has_HVZ been_BEN produced_VBN=>(A=produced)

The rules for extraction of Subject, Action and Object are formed as follows:

1. To extract the Action, tag chains are built, e.g., manually, for all possible verb forms in active and passive voice with the help of the Classifier (block 3). For example, have been produced=<HVZ><BEN><VBN>.

2. In each tag chain the tag is indicated corresponding to the main notion verb (in the above example−<VBN>). Also, the type of the tag chain (active or passive voice) is indicated.

3. The tag chains with corresponding indexes formed at steps 1-2 constitute the basis for linguistic modules extracting Action, Subject and Object. Noun groups constituting Subject and Object are determined according to the type of tag chain (active or passive voice).

The recognition of such elements as Indirect Object, Adjective and Adverbial is implemented in the same way, that is taking into account the tags and the structure itself of Syntactical Phrase Tree.

Recognition of Subject, Object and Indirect Object attributes is carried out on the basis of corresponding Recognizing Linguistic Models. These models describe rules (algorithms) for detecting subjects, objects, their attributes (placement, inclusion, parameter, etc.) and their meanings in syntactic tree.

To identify parameters of an Object (Indirect Object, Subject) Parameter Dictionary is used. A standard dictionary defines whether a noun is an object or a parameter of an object. Thus, a list of such attributes can easily be developed and stored in Linguistic KB (Block 80). For example, temperature (=parameter) of water (=object). To identify attributes such as placement, inclusion etc., Linguistic KB includes a list of attribute identifiers, i.e. certain lexical units. For example, to place, to install, to comprise, to contain, to include etc. Using such lists, the system may automatically mark the eSAOs extracted by eSAO extractor which correspond to said attributes.

These algorithms work with noun groups and act like linguistic patterns that control extraction of above-mentioned relations from the text. For example, for the relations of type parameter-object, basic patterns are

<Parameter> of <Object>

and

<Object> <Parameter>

The relation is valid only when the lexeme which corresponds to <parameter> is found in the list of parameters included in Linguistic KB.

These models are used by Unit 76 of eSAO extraction module. The output of the unit is a set of 7 fields, where some of the fields may be empty.

For example (for the highlighted fragments of the first two sentences given above):

1) The dephasing waveguide is fitted with a thin dielectric semicircle at one end, and a guide cascaded with the dephasing element completely suppresses unwanted modes.

Subject: guide cascaded with the dephasing element

Action: suppresses

Object: unwanted modes

Preposition

IndirectObject

Adjective

Adverbial: completely

2) It was found that the maximum value of x is dependent on the ionic radius of the lanthanide element.

Subject: maximum value of x

Action: be

Object

Preposition: on

IndirectObject: the ionic radius of the lanthanide

element

Adjective: dependent

Adverbial

At the stage 77 User Request eSAO Extractor recognizes constraints, i.e., those lexical units of the query, which are not parts of eSAO.

The constraints can be represented by any lexical unit except:

(a) Question Words

enc_WP, enc_WRB, enc_WDT

Example: what, how, where

(b) Articles

enc_AT, enc_ATI

Example: a, an, the

(c) Helpers:

enc_DO, enc_DOD, enc_DOZ, enc_MD, enc_IN, enc_XNOT, enc_TO,enc_HV, enc_HVZ, enc_HVD,enc_BE, enc_BEZ, enc_BER, enc_BED, enc_BEDZ, enc_BEM

Example: do, did, does

(d) Personal Pronouns

enc_PPusd,enc_PPusd2,enc_PP1A,enc_PP1AS,enc_PP1O,enc_PP1OS, enc_PP2, enc_PP3, enc_PP3A, enc_PP3AS, enc_PP3O, enc_PP3OS, enc_PPL, enc_PPLS, enc_PP

Example: I, we, they

(e) Other Pronouns

enc_PN, enc_PNq2, enc_PNusd, enc_PNusdq2

Example: same, each, something

(f) Determiners enc_DT, enc_DTusd, enc_DTI, enc_DTS, enc_DTX, enc_EX

Example: this, those, these

(g) Because, If

enc_CS

Example: because, if, since, after

(h) Punctuation:

enc_Exclamatory, enc_AmpersandFW, enc_RLBracket, enc_RRBracket,enc_LeftQuote, enc_RightQuote,

enc_MultipleMinus, enc_Comma, enc_FullStop,

enc_Spot3, enc_Colon, enc_Semicolon, enc_Question

Example: “, ', ?, !, . . .

(i) Others:

enc_UH, enc_CC, enc_OD, enc_CD

Example: Oh!, and, or

As a result, eSAO extractor 42 outputs eSAO request in the form of a set of, for example, 8 fields where some of the fields may be empty:

1. Subject

2. Action

3. Object

4. Preposition

5. Indirect Object

6. Adjective

7. Adverbial

8. Constraints

Along with that, Subject, Object and Indirect Object each have inner structure, as described above.

In case of “bit sentence” and “complex query”, more than one set of fields is possible. For instance:

(“Bit Sentence”)

Input: clean water

Output:

(a)

Subject:

Action:

Object: clean water

Preposition:

Indirect Object:

Adjective:

Adverbial:

Constraints:

(b)

Subject:

Action: clean

Object: water

Preposition:

Indirect Object:

Adjective:

Adverbial:

Constraints:

(“Statement”)

Input: Give me the number of employees in IMC company.

Output:

Subject:

Action:

Object: number of employees in IMC company

Preposition:

Indirect Object:

Adjective:

Adverbial:

Constraints:

(“Question”)

Input: What is the chemical composition of the ocean?

Output:

Subject: chemical composition of the ocean

Action: is

Object: What

Preposition:

Indirect Object:

Adjective:

Adverbial:

Constraints:

(“Question”)

Input: Do the continents move?

Output:

Subject: continents

Action: move

Object:

Preposition:

Indirect Object:

Adjective:

Adverbial:

Constraints:

(“Complex Query”)

Input: My 15-year-old son has recently been diagnosed with recurrent shoulder dislocation. Lately he got worse. How is recurrent shoulder dislocation treated?

Output:

Subject:

Action: treat

Object: recurrent shoulder dislocation

Preposition:

Indirect object:

Adjective:

Adverbial:

Constraints: 15-year-old, son, diagnose

At the final stage of processing the user request Semantic Processor forms Search Patterns which are Boolean expressions in case of “keywords”, and eSAOs in other cases. Also, sign “?” may be present in some eSAO fields to signal that this field must be filled in to answer the user request.

For example:

(“Bit Sentence”)

Input: clean water

Output:

(a)

Subject: any

Action: any

Object: clean water

Preposition: any

Indirect Object: any

Adjective: any

Adverbial: any

Constraints :any

(b)

Subject: any

Action: clean

Object: water

Preposition: any

Indirect Object: any

Adjective: any

Adverbial: any

Constraints: any

(“Statement”)

Input: Give me the number of employees in IMC company.

Output:

Subject: Something1

Action: any

Object: number of employees in IMC company

Preposition: any

Indirect Object: any

Adjective: any

Adverbial: any

Constraints: any

(“Question”)

Input: What is the chemical composition of the ocean?

Output:

Subject: chemical composition of the ocean

Action: be

Object: ?

Preposition: any

Indirect Object: any

Adjective: any

Adverbial: any

Constraints: any

(“Question”)

Input: Do the continents move?

Output:

Subject: continents

Action: move

Object: any

Preposition: any

Indirect Object: any

Adjective: any

Adverbial: any

Constraints: any

(“Complex Query”)

Input: My 15-year-old son has recently been diagnosed with recurrent shoulder dislocation. Lately he got worse. How is recurrent shoulder dislocation treated?

Output:

Subject: somethingl

Action: treat

Object: recurrent shoulder dislocation

Preposition: any

Indirect object: any

Adjective: any

Adverbial: any

Constraints: 15-year-old, son, diagnose

If no eSAO field contains the “?” sign, that means the question is general. Absence of an element in a field (“any”) means that this field can contain anything.

Functionality of all modules of the Semantic Processor is maintained by Linguistic Knowledge Base 12 which includes Database (dictionaries, classifiers, statistical data, etc.) and Database of Recognizing Linguistic Models (for text-to-words splitting, recognition of noun phrases,verb phrases, subject, object, action, attribute, “type-of-sentence” recognition, etc). See References Nos. 3, 4, and 5 above.

Thus, the output search patterns at 10 in FIG. 1 can be used to search for matching eSAO's in eSAO Knowledge Base in the system with much more accuracy and reliability than prior systems and methods even for requests being in the form of questions. In addition, the eSAO format enables greater accuracy in obtaining precise information of interest.

Simultaneously, the user is offered the opportunity to receive possibly less relevant information, owing to the strategy of less strict identity between the corresponding fields in search patterns and in documents processed during the search. Thus, for example, in the case of the last example:

Subject: something

Action: treat

Object: recurrent shoulder dislocation

Preposition: any

Indirect object: any

Adjective: any

Adverbial: any

Constraints: 15-year-old, son, diagnose

Semantic Processor additionally can form a set of less relevant search patterns, by means of gradual refusal of “Constraints” field elements and further—of recognized “Object” attributes, owing to:

recurrent=Attr (shoulder dislocation)

shoulder=Attr (dislocation)

Thus, the less relevant search pattern will be:

Subject: something

Action: treat

Object: dislocation

Preposition: any

Indirect object: any

Adjective: any

Adverbial: any

Constraints: any

Note the constraint has been removed, which can be in response to a user-entered command.

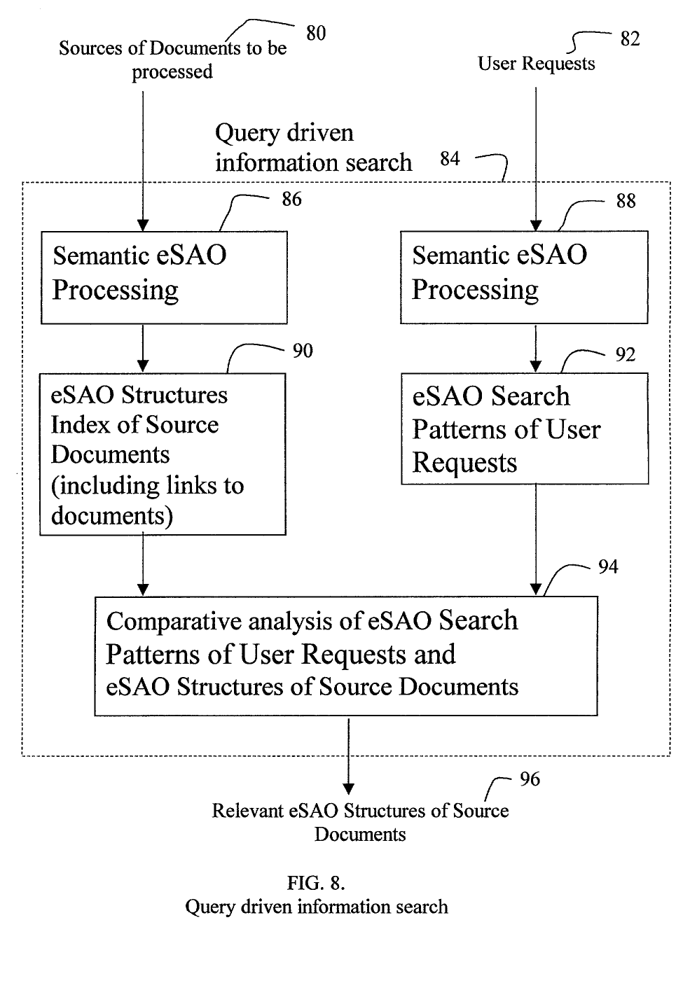

With reference to FIG. 8, the query driven information search 84 includes a semantic eSAO processing 86, 88 for creating eSAO structures index or Knowledge Base (including links to documents) 90 of source documents 80 and eSAO search patterns 92 of user requests 82. See references nos. 2 and 4 for further details on creating one example of a Knowledge Base. The present Knowledge Base, however, can have up to 8 fields for the eSAO structures and constraints as described above. The search module 84 further includes comparative analysis 92 of eSAO search patterns 92 of user requests and eSAO structures index 90 of source documents. The comparative analysis 92 identifies the eSAO structures 96 of source documents, which are most relevant for eSAO search patterns of given user requests. These structures can be displayed to the user in order of relevance and the full source sentence of user selected structure and link to the full document can be displayed. User selection of the document link shall access the full source document for display of the paragraph or paragraph segment that includes the eSAO components which can be highlighted for quick recognition. This document display is scrollable through the entire document, see references nos. 2, 4, and 5 for further details of these functions.

It will be understood that various modification and improvements can be made to the herein disclosed exemplary embodiments without departing from the spirit and scope of the present invention.

We claim:

1. In a digital computer, the method of processing a natural language expression entered or downloaded to the computer comprising:
identifying in the expression expanded subject, action, object (eSAO) components comprising at least four components including subject, action, object components and at least one additional component from the class of preposition component, indirect object component, adjective component, and adverbial component, and
extracting each of said at least four components for designation into a respective subject, action, object field and at least one respective field from the class of preposition field, indirect object field, adjective field, and adverbial field, and
using the components in at least certain ones of said fields for at least one of (i) component display to the user, (ii) forming a search pattern of a user request for information search of local or on-line databases, and (iii) forming an eSAO knowledge base.

2. In the method of claim 1 wherein,
the expression comprises a user request for information search, said method further comprising classifying the expression into at least one category from the class that includes bit sentence, statement sentence, question sentence, and complex query, and
simplifying the user request search pattern by applying rules in accordance with the respective expression category.

3. In the method of claim 2 wherein,
the rules include transforming a question sentence rules according to
1 2 3 4 5→3 2 4 1 5
or
1 2 3 4 5→3 2 4 5 1
wherein

| | |
|---|---|
| 1 | <wh-group> |
| 2 | <First Verbal Group> |
| 3 | NG (Noun Group) |
| 4 | <Second Verbal Group> |
| 5 | TL (tail) |

4. The method of claim 1 wherein,
the expression comprises a sentence of a document download to the computer and wherein said process comprises using the components for forming an indexed eSAO knowledge base entry, and
selecting the eSAO entry for display of the eSAO components, or of the source expression that includes the eSAO components, in response to a user request that includes at least a subset of the expression eSAO components.

5. The method of claim 1 wherein,
the expression includes constraint components that includes components that are not classified in any other component type,
said extracting step, further includes extracting constraint components for designation into a constraint field, and
said using step further includes using the components in at least certain ones of said fields for at least one of (i) component display to the user, (ii) forming a search pattern of a user request for information search of local or on-line databases, and (iii) forming an eSAO knowledge base.

6. The method of claim 5 wherein,
the object field includes an object component field segment and an attribute field segment.

7. The method of claim 6 said method further comprising
forming a less relevant user request search pattern by deleting one or more components from the constraint field or one or more attributes from the object field.

8. The method of claim 4 wherein,
the expression comprises part of a downloaded document, said method further classifying the expression into at least one category from the class that includes bit sentence, statement sentence, question sentence.

9. The method of claim 8 wherein,
the expression includes a question sentence and transforming the sentence according to the rule
1 2 3 4 5→3 2 4 1 5
or
1 2 3 4 5→3 2 4 5 1
wherein

| | |
|---|---|
| 6 | <wh-group> |
| 7 | <First Verbal Group> |
| 8 | NC (Noun Group) |
| 9 | <Second Verbal Group> |
| 10 | TL (tail) |

10. The method of claim 8 said method comprising,
processing all of the natural language expressions from a plurality of downloaded documents into an eSAO Knowledge Base.

11. The method of claim 10 said method further comprising,
providing communication access to said eSAO knowledge base by a plurality of user computers, processing natural language user requests into eSAO search patterns and conveying to respective users expressions and source document links for respective expression whose eSAO field components substantially match the eSAO components of the respective user requests.
